(19) United States
(12) Patent Application Publication
(10) Pub. No.: US 2007/0236541 A1
(43) Pub. Date: Oct. 11, 2007

(54) Printhead and inkjet printer comprising such a printhead

(75) Inventor: Hermanus M. A. Wijshoff, Grevenbicht (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/783,038

(22) Filed: Apr. 5, 2007

(30) Foreign Application Priority Data
Apr. 6, 2006 (EP) 06112278

(51) Int. Cl. B41J 2/045

(52) U.S. Cl. 347/69

(57) ABSTRACT

A printhead including multiple, substantially closed ink chambers, the ink chambers being mutually separated by at least one wall, wherein each of the chambers is provided with an electromechanical converter, the actuation of the converter leading to a volume change of the corresponding chamber. Also disclosed is to an inkjet printer containing such a printhead.

This application claims priority from European Patent Application No. 06112278.4 filed on Apr. 6, 2006, the entire contents of which is hereby incorporated by reference in its entirety.

### BACKGROUND OF THE INVENTION

The present invention relates to a printhead comprising multiple substantially closed ink chambers, the ink chambers being mutually separated by at least one deformable wall, wherein each of the chambers comprises an electro-mechanical converter, the actuation of the converter leading to a volume change of the corresponding chamber. The present invention also relates to an inkjet printer comprising such a printhead.

A printhead of this kind is known from U.S. Pat. No. 5,617,127. This printhead comprises one or more ink chambers substantially entirely defined by an integral ceramic substrate, the rigidity of the ceramic substrate being very high to prevent deformation of the walls. The ceramic substrate comprises a closure plate on top of which one or more bimorph actuators are applied, where actuation of the actuators leads to a volume change of the corresponding ink chamber(s). A major drawback of the known printhead is that relatively high voltages are required to actuate to the actuators to cause a volume change of the ink chambers, which makes the known printheads relatively energy-consuming, and hence relatively inefficient.

### SUMMARY OF THE INVENTION

It is an object of the present invention is to provide a relatively efficient printhead. This object can be achieved by providing a printhead wherein the wall and the converter are adapted for mutual cooperation, such that, based on this cooperation, actuation of the converter of an ink chamber leads to buckling of the converter. Actuation of the converter will elastically bend (a part of) the deformable wall outwardly, which causes the converter to buckle upwardly, thereby (temporarily) increasing the volume of the ink chamber. According to the present invention, it has been found that this (reversible) buckling effect of the converter significantly increases the efficiency of the converter and hence of the functioning of the printhead. More particularly, due to this buckling effect the presence of a relatively thick passive (inert) intermediate layer, such as a conventional (ceramic) closure plate, onto which the converter is superimposed is no longer required and can therefore be omitted. Omission, or at least a reduction of the thickness of a conventional passive layer results in a relatively low voltage of less than 10 Volt being required to actuate the converter in a satisfying manner to cause a controlled volume change of the ink chamber(s). Applying relatively low voltages to actuate the converter leads to a corresponding saving in energy, and hence a relatively efficient printhead for an inkjet printer. A further advantage of the printhead is that the wall(s) will be partially deformed upon actuation of the converter. By allowing merely a (substantial) partial, and preferably a (location) selective deformation of the wall, cross-talk between adjacent ink chambers can be counteracted in a relatively efficient and satisfying manner. Advantageously, the wall comprises a first wall side (partially) defining a first chamber and a second wall side, opposite to the first wall side, said second wall side (partially) defining a second, neighboring chamber, wherein the walls are deformable, such that actuation of the converter of the first chamber leads to a deformation of the wall, the deformation of the first wall side is being substantially larger than the deformation of the second wall side. Although the deformation behavior of the wall can be optimized for the printhead to allow merely a partial deformation upon the actuation of the converter, it is recognized that frequently it will not be possible to prevent actuation of a converter to produce a (slight) volume change in an adjacent chamber. This is because it is difficult to achieve both a full power closure between adjacent converters and also prevent stretching of the chambers. However, by optimizing the deformation behavior of the wall, being determined by the material, the shape and the dimensioning of the wall and the like, cross-talk between adjacent ink chambers can be minimized, and can be reduced to less than one percent.

In a preferred embodiment of the printhead according to the present invention, the wall has a tapered configuration. According to this embodiment the first wall side and the second wall side of the wall are oriented in a non-parallel orientation with respect to each other. This leads to an improved storage capacity of elastic energy within the wall and to an advantageous wall deformation and to an efficient buckling of the converter upon actuation of the converter.

In a preferred embodiment, the wall is made of a material having a Young's modulus (E modulus) smaller than 60 GPa, preferably less than 30 Gpa, and more preferably around 10 GPa. In this embodiment, the wall between adjacent ink chambers is made from a relatively easily deformable (elastic) material with a relatively good shape recovery ability. This means that the wall can be made relatively thick without restrictions in deformability becoming an issue. An allowed robustness of the walls facilitates a less critical and a relatively simple manufacturing of the printhead according to the present invention.

Although the wall can be made of various materials, the wall is preferably made at least partially from at least one of the following materials: carbon, ceramics, and polymer, in particular an elastomer. Carbon combines the special advantages of low rigidity, typically 14 GPa, and good machinability, so that it is relatively simple to form such elements as channel plates in which the chambers and walls are joined. In case the wall (or any other part of the printhead) is made of multiple materials, preferably materials are used which have, more or less, similar coefficients of thermal expansion.

In a preferred embodiment the printhead comprises a carrier plate provided with at least one wall, wherein the carrier plate and the one wall are made of substantial similar materials. In this embodiment, the chambers and walls may easily be made by milling the chambers from a carbon element, which automatically produces a carbon wall between the chambers. When selecting a certain type of carbon, the wall thickness and height requirements may be determined based on experiments or a model that may be applied in accordance with the present invention.

The electro-mechanical converter comprises at least one piezo-electric element. In a particular preferred embodiment the piezo-electric element comprises a (relatively thin) single piezo-electric layer of between 10 and 30 micrometer which require relatively low electric actuation voltages of less than 40 volt. To prevent the piezo-electric element from contacting ink contained in the ink chamber, the electro-mechanical converter is preferably provided with a protective layer. This protective layer is preferably made of a thin foil (film) made of a metal or a polymer, in particular a polyamide. The thickness of the protective foil may vary from several micrometers up to 30 micrometer. However, it is also conceivable to apply a multi layer piezo-electric element, in which multiple piezo-electric layers are present.

The invention also relates to an inkjet printer comprising at least one printhead as described above. Such a printhead may be applied without producing undesirable print artefacts in a printed image.

### BRIEF DESCRIPTION OF THE DRAWINGS

The present invention will further be elucidated by means of the following non-limitative illustrative embodiments, wherein:

FIG. 1 shows an inkjet printer comprising multiple printheads according to the present invention,

FIG. 2 shows a cross-section of a printhead during inaction as used in the inkjet printer according to FIG. 1, and

FIG. 3 shows a cross-section of the printhead according to FIG. 2 during operation.

### DETAILED DESCRIPTION OF THE INVENTION

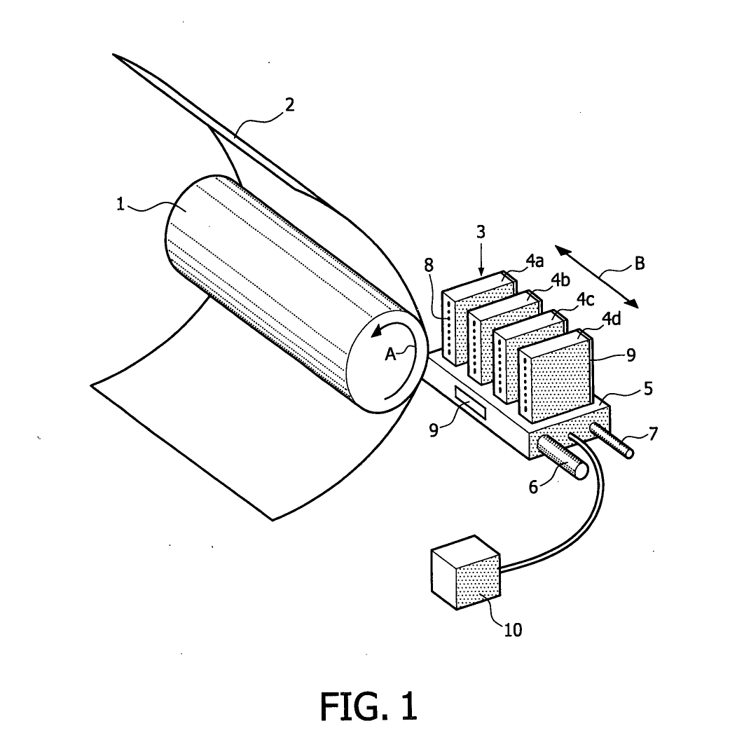

FIG. 1 is a diagram showing an inkjet printer. According to this embodiment, the printer comprises a roller 1 used to support a receiving medium 2, such as a sheet of paper or a transparency, which is traversed by the carriage 3. The carriage 3 comprises a carrier 5 to which four printheads 4a, 4b, 4c and 4d have been fitted. Each printhead 4a, 4b, 4c, 4d contains its own color, in this case cyan (C), magenta (M), yellow (Y) and black (K), respectively. The printheads 4a, 4b, 4c, 4d are heated using heating elements 9, which have been fitted to the rear of each printhead 4a, 4b, 4c, 4d and to the carrier 5. The temperature of the printheads 4a, 4b, 4c, 4d is maintained at the correct level by application of a central control unit 10 (controller). The roller 1 may rotate around its own axis as indicated by arrow A. In this manner, the receiving medium may be moved in the sub-scanning direction (often referred to as the X direction) relative to the carrier 5, and therefore also relative to the printheads 4a, 4b, 4c, 4d. The carriage 3 may be moved in reciprocation using suitable drive mechanisms (not shown) in a direction indicated by double arrow B, parallel to roller 1. To this end, the carrier 5 is moved across the guide rods 6 and 7. This direction is generally referred to as the main scanning direction or Y direction. In this manner, the receiving medium 2 may be fully scanned by the printheads 4a, 4b, 4c, 4d. According to the embodiment as shown in this figure, each printhead 4a, 4b, 4c, 4d comprises a number of internal ink chambers (not shown), each with its own exit opening (nozzle) 8. The nozzles 8 in this embodiment form one row per printhead perpendicular to the axis of roller 1 (i.e., the row extends in the sub-scanning direction). In a practical embodiment of an inkjet printer, the number of ink chambers per printhead will be many times greater and the nozzles 8 will be arranged over two or more rows. Each ink chamber comprises a piezo-electric converter (not shown) that may generate a pressure wave in the ink chamber so that an ink drop is ejected from the nozzle of the associated chamber in the direction of the receiving medium 2. The converters may be actuated image-wise via an associated electrical drive circuit (not shown) by application of the central control unit 10. In this manner, an image made up of ink drops may be formed on receiving medium 2. If a receiving medium 2 is printed using such a printer where ink drops are ejected from ink chambers, this receiving medium 2, or some of it, is imaginarily split into fixed locations that form a regular field of pixel rows and pixel columns. According to one embodiment, the pixel rows are perpendicular to the pixel columns. The individual locations thus produced may each be provided with one or more ink drops. The number of locations per unit of length in the directions parallel to the pixel rows and pixel columns is referred to as the resolution of the printed image, for example indicated as 400×600 d.p.i. (“dots per inch”). By actuating a row of printhead nozzles 8 of the inkjet printer image-wise when it is moved relative to the receiving medium 2 as the carrier 5 moves, an image, or some of it, made up of ink drops is formed on the receiving medium 2, or at least in a strip as wide as the length of the nozzle row.

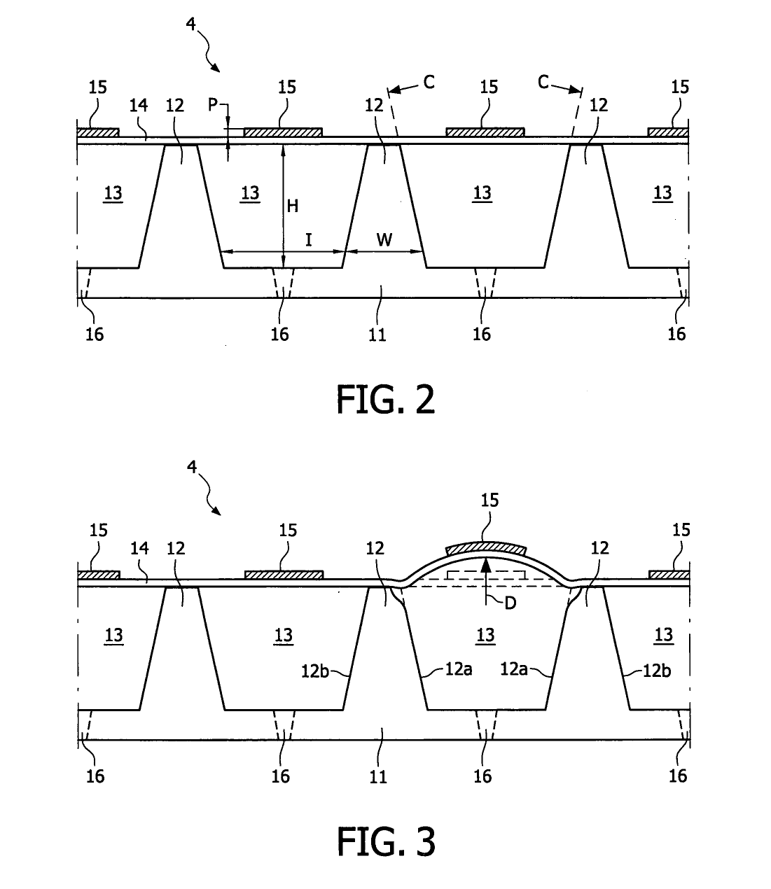

FIG. 2 shows a cross-section of a printhead 4 according to the present invention as used in the inkjet printer according to FIG. 1. The printhead 4 comprises a base structure 11 provided with multiple tapered walls 12 to define multiple ink chambers 13. The ink chambers 13 are closed by a compliant foil 14 onto which electro-mechanical converters 15 have been placed. Each converter 15 comprises a single layer piezo-electric (generally applied PZT material) element with a thickness P of between 1 and 20 micrometers. The compliant foil 14 is in this embodiment a 10 micrometer thick Upilex polyamide foil (E modulus 9 GPa). The ink chambers 13, as shown, have a (minimum) width I of 100 micrometer and a height H of 100 micrometer. The ink chambers 13 are milled into the 2 mm thick carbon base structure 11, thereby generating tapered separation walls 12 having a maximum width W of 69 micrometer. As these walls are made from carbon, they may reversibly deform in a direction substantially parallel to directions C as indicated. The chosen thickness W, together with the wall configuration as a component of the base structure 11 means that they deform relatively easily, if the pressure inside a chamber changes. The deformable separation walls 12 and the converter(s) 15 are adapted to cooperate, such that actuation of a converter 15 of an ink chamber 13 leads to buckling of the converter 15 (see FIG. 3). Forcing the converter 15 to buckle is in favor of a controlled volume change of the ink chamber 13 and requires merely a relatively low voltage of less than 10 Volt to become actuated, which therefore makes the printhead relatively energy-saving and hence efficient. The walls 12 are designed such that merely a partial deformation will occur upon actuation of the piezo-electric converter 15. This partial deformation will not lead to a (noticeable) volume change in an adjacent ink chamber 13 upon actuation of the piezo-electric converter 15, as will be discussed further hereinafter. Each ink chamber 13 is provided with a nozzle 16 for discharging ink contained within said chamber 13 upon actuation of the converter 15.

FIG. 3 schematically shows a cross-section of the printhead 4 according to FIG. 2 during operation. One of the converters 15 is actuated in the shown embodiment of the printhead 4 by applying a relatively low voltage of e.g., 7 Volt to said converter 15, as a result of which said converter 15 (temporarily) buckles upwardly (see arrow D) thereby increasing the volume of the corresponding ink chamber 13. The direction of the deformation of the converter 15 is forced by the shape and material of the tapered walls 12. As shown in FIG. 3 each tapered wall 12 (partially) defining the chamber 13 is deformed partially and location selectively, such that an adjacent chamber 13 is not subjected to a (considerable) net volume change. More particularly, merely a (first) wall side 12a of each wall 12 (partially) defining the ink chamber 13 is substantially deformed, while an opposite (second) wall side 12b of each wall 12 (partially) defining a neighbouring ink chamber 13 is not subjected to substantial deformation. As a result cross-talk between adjacent chambers 13 of the printhead 4 can be prevented, or at least forced back considerably, in a relatively efficient manner.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim.

1. A printhead comprising a multiplicity of substantially closed ink chambers, said ink chambers being mutually separated by at least one deformable wall, wherein each of the chambers is provided with an electromechanical converter, the actuation of the converter causing a volume change of the corresponding chamber, wherein the wall and the converter mutually cooperate such that actuation of the converter of an ink chamber leads to buckling of the converter.

2. The printhead according to claim 1, wherein the wall comprises a first deformable wall side defining a first chamber and a second deformable wall side opposite to the first wall side, said second wall side defining a second, neighboring chamber.

3. The printhead according to claim 1, wherein the wall has a tapered configuration.

4. The printhead according to claim 1, wherein the wall is made of a material having a Young's modulus smaller than 60 GPa, preferably smaller than 30 GPa.

5. The printhead according to claim 1, wherein the wall is made of at least one material selected from the group consisting of carbon, ceramics, polymers, and elastomers.

6. The printhead according to claim 1, wherein the printhead includes a carrier plate provided with the at least one wall said carrier plate and at least one wall being made of substantial similar materials.

7. The printhead according to claim 1, wherein the electromechanical converter comprises at least one piezo-electric element.

8. The printhead according to claim 1, wherein the electromechanical converter is provided with a protective layer.

9. The printhead according to claim 1, wherein the electromechanical converter is adapted to increase the volume of the corresponding chamber during actuation of the converter.

10. An inkjet printer comprising at least one printhead according to claim 1.
